(19) United States
(12) Patent Application Publication
(10) Pub. No.: US 2021/0366147 A1
(43) Pub. Date: Nov. 25, 2021

(54) Process for detection of position of body parts based on facial image

(71) Applicant: STYLEDOTME FASHION AND LIFESTYLE PRIVATE LIMITED, DELHI (IN)

(72) Inventors: Akhil Tolani, Delhi (IN); Lalit Vijay, Jharkhand (IN); Meghna Saraogi, Indore (IN)

(21) Appl. No.: 16/873,606

(22) Filed: May 20, 2020

(51) Int. Cl. G06T 7/73; G06K 9/00; G06K 9/32; G06T 7/60; G06T 11/00

(52) U.S. Cl. CPC G06T 7/73; G06K 9/00255; G06K 9/00281; G06T 2207/30201; G06T 7/60; G06T 11/00; G06K 9/3208

(57) ABSTRACT

The present invention is a system and improved process for detection of position of body parts based on facial image. The present invention has several advantages over the prior arts described, like, the number of ornamental articles which the user can apply using the simulated process in accordance with the present invention is significantly faster, higher since the present invention obviates the need for physical space to maintain inventory and is less time consuming. Moreover, the present invention enables the user to simulate the application of a large inventory of articles, particularly ornamental articles, without visiting a store. The present invention obviates the need for physically applying an ornamental article, headgear, or makeup to a pre-designated part, such as ears, head or neck of a user. The present invention is an augmented reality application that enables people to virtually try-on jewelry, makeup or any article on their faces.

### TECHNICAL FIELD

The present subject matter in general relates to improved system and process for detection of pre-designated parts of a user's body in the image of a human face, such as an ornamental article, on a pre-designated part of user's body, such as at least one ear or neck of the user.

### BACKGROUND

With respect to the jewelry and fashion industry, there has been little innovation in the overall shopping experience. Conventional methods of trying an ornamental article, requires a user to apply each ornamental article on a part of a user's body and thereafter view the user's body part on a reflective object such as a mirror. Thereafter, the user removes the ornamental article and may choose to apply another ornamental article on said body part. With the increase of user-generated, product review websites such as Yelp™, Amazon™ Zappos™ and others, the voice of the customer (VOC) continues to rise and consumers are becoming increasingly more demanding of their products and services they pay for. Consumers continue to be challenged with the daunting task of deciding from hundreds and sometimes thousands of choices and styles which to choose from. Consumers are demanding and searching for innovative solutions to improve their overall user experience and assurances that the final product meets both their style and comfort criteria.

Therefore, there is a need to eliminate the conventional methods of applying articles, such as ornamental articles, directly on a user's body part. Techniques for detecting and recognizing face of a human being in an image are known in the art. As described by Yang et al., in “Detecting Faces in Images: A Survey (2002)”, there are four known methods for detection of faces in images, namely, knowledge-based methods, feature invariant approach, template matching methods and appearance-based methods. Similarly, Viola and Jones describe techniques for face detection in “Rapid Object Detection using a Boosted Cascade of Simple Features (2001)”.

One such technique is face detection technique that detects a face in an image consisting of several objects including a face. Facial Landmark detection techniques described in U.S. Pat. Nos. 9,471,829; 7,027,622 and 9,361,510 uses face landmarking points and detects the position of only specific points on the image of a face, such as corners of eyes, corners of lips, mouth and tip of the chin. Ear and neck detection and recognition techniques are also known in the art. However, conventional ear detection and recognition techniques necessarily require ears to be visible in the image of the face and are unable to detect and/or recognize them based on a frontal image of a human face. Ear recognition techniques known in the art do not disclose or teach any mechanism to detect the neck edges or position of ear lobes or ear helix based on a frontal image of the face of a user or an image of a face in which ear lobes or a portion of an ear and neck are not visible or are obscured by an object, such as hair.

Therefore, it is desired to address or at least alleviate one or more difficulties or limitation of the prior art of existing face detection, recognition and landmarking techniques.

### SUMMARY

The present invention alleviates the above-mentioned disadvantages and shortcomings of the present state of the art through the discovery newly located ear points in addition to 68 landmarking points are used to overlay jewelry items on the face. The present invention obviates the need for physically applying an ornamental article, headgear, or makeup to a pre-designated part, such as ears, head or neck of a user. The present invention is an augmented reality application that enables people to virtually try-on jewelry, makeup or any article on their faces.

The main object of the present invention is to simulate an easy and accurate physical application of an article, such as an ornamental article, headgear, or makeup, without requiring the user to physically apply the article to their body part, such as user's any part of face, neck or ear.

It is an object of the present subject matter to superimpose an image of an article, such as an ornamental article, on a pre-designated part of user's body, such as an ear lobe or neck of the user.

It is yet another object of the present subject matter is to significantly increase the number of articles which the user can apply using simulated process by faster process of application and removal of articles.

It is yet another object of the present subject matter to enable a user to simulate the application of a large inventory of articles without visiting a store.

It is yet another object of the present subject matter to superimpose an image of an article in a moving position of an ear lobe, an ear helix or edges of the neck in a moving image of a human face.

It is yet another object of the present subject matter to detect the position of an ear lobe, an ear helix or edges of the neck even if the ear lobe, the ear helix or the neck is not visible in the image or is obscured by hair and/or other objects.

### BRIEF DESCRIPTION OF THE DRAWINGS

FIG. 1 depicts face landmarking points falling on the jawline of the face in accordance with the present invention

FIG. 2 depicts face landmarking points falling on the uppermost layer of points falling on the face and face landmarking points falling on the lowermost layer of points falling on the face in accordance with one embodiment of the present subject matter.

FIG. 3 discloses steps in accordance with the present invention for detection of pre-designated parts of a user's body in the image of a human face.

FIG. 4 depicts face landmarking points falling at 0 degrees of Ear and Neck points.

FIG. 5 depicts face edge detection based on adjustment of Ear & Neck points

### DETAILED DESCRIPTION OF THE PRESENT INVENTION

The present invention is a system and improved process for detection of position of body parts based on facial image. The present invention has several advantages over the prior arts described, like, the number of ornamental articles which the user can apply using the simulated process in accordance with the present invention is significantly faster, higher since the present invention obviates the need for physical space to maintain inventory and is less time consuming. Moreover, the present invention enables the user to simulate the application of a large inventory of articles, particularly ornamental articles, without visiting a store.

The system in accordance with the present invention includes an image capturing device for capturing an image containing a human face; a display device for displaying or reproducing the image captured by the image capturing device; and a processor unit that determines and crops part of the image that encompasses the face, determines reference face-landmarking points falling on the jawline of the face and rotation of the face in the image, corrects the rotation of the face in the image, determines the vertical size or height of the face, corrects the offset distance from reference face-landmarking points for the height of the face so determined, adds the offset distance to the reference face-landmarking points for determining the position of ear lobes and neck edges on the image of the human face and runs edge detection to adjust estimated ear and neck points.

In an embodiment in accordance with the present invention, the image capturing device comprises of a camera, which may be integrated with a computing system, such as a tablet and the display device comprises a screen, which may be integrated with the camera individually or may form part of the computing system, such as a tablet.

In another embodiment in accordance with the present invention, the processor unit comprises one or more processors, which one or more processors including one or more or logic circuitries for processing instructions, general-purpose processors, special purpose processors, digital signal processors (DSP), microprocessors, micro-controllers, controller or the like. It is the processor unit that determines rotation of the face in the image on x-axis, y-axis and/or z-axis. The processor unit in accordance with the present invention corrects the rotation of the face in the image along the x-axis, y-axis and/or z-axis such that the rotation along each of the axes is 0 degrees. The processor unit determines the vertical size or height of the face by determining the distance between face landmarking 3 points falling on the uppermost layer of points falling on the face and face landmarking points falling on the lowermost layer of points falling on the face.

A process for detecting the position of an ear lobe, an ear helix and/or neck edges in an image of a human face with accuracy is also described herein. The process in accordance with the present invention includes the steps of determining and cropping part of the image that encompasses the face; determining reference face-landmarking points falling on the jawline of the face and rotation of the face in the image on x-axis, y-axis and/or z-axis; correcting the rotation of the face in the image; determining the vertical size or height of the face; correcting the offset distance from reference face-landmarking points for the height of the face so determined; and adding the offset distance to reference face-landmarking points for determining the position of an ear lobe, an ear helix and the neck area on the image of the human face. One of the major advantages of the process in accordance with the present invention is that the process described herein does not rely on visibility of ear lobes, ear helix or the neck area in an image of a human face. The position of ear lobes, ear helix or the neck can be determined even if the ear lobes and the neck are not visible at all in the image or are obscured by hair and/or other objects.

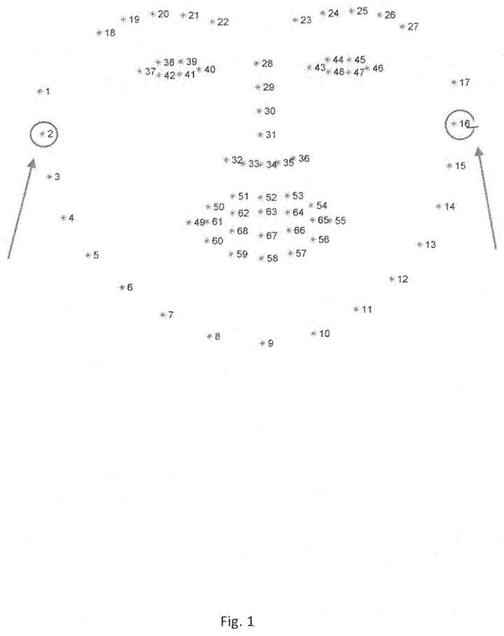

As shown in FIG. 1, Point 2 X coordinates and Point 7 from Y coordinates are used to identify the width & position for earlobes & Neck in accordance with the present invention. Point 2 as shown in the FIG. 1 from X coordinates and Point 7 from Y coordinates are marked as “L” and “R” of the face image. After that it starts iterating pixels from “L” to “R” to draw the canny edge image until it hits a white pixel (i.e. the left edge of the neck). This point will be new “L” and similarly the values for “R” is also updated. Thus to achieve the width of the neck; we subtract X coordinates of “R” and “L”.

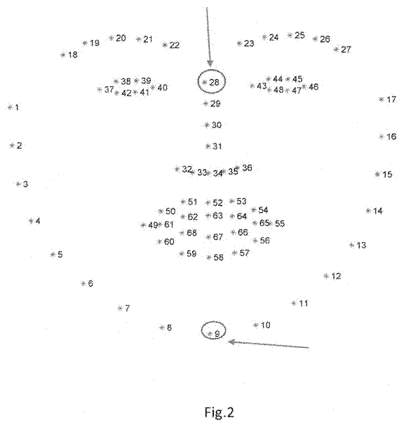

In the same embodiment in accordance with the present invention, the step of determining the vertical size or height of the face is performed by determining the distance between face landmarking points falling on the uppermost layer of the points falling on the face and face landmarking points falling on the lowermost layer of the points falling on the face. Using the above ears & neck points coordinates, the present invention runs canny edge detection around 0.05*face Height square area of the points on the facial image. This area is then used to create a mask and perform any final adjustments that might be required for the ears and neck points. This process is shown in FIG. 2. In FIG. 2 a vertical face height is achieved by taking points 28 and 9 and subtracting y coordinates from them. We can use this height in accordance with the present invention as a fixed unit according to the distance of face from camera which will be useful in scaling of jewelry as the user changes distance from the camera. The rotation of a human face in an image about each of the axes is determined using techniques known in the prior art.

In accordance with the present invention, the step of correcting the rotation of the face in the image includes correction along the x-axis, y-axis and/or z-axis, such that the rotation along each of the axes is 0 degrees. This process is run whenever the rotation angle of face is zero in x, y and z axes and update the value of neck & earlobe width. Similarly, this process is run around the ear to find out the width of the earlobe.

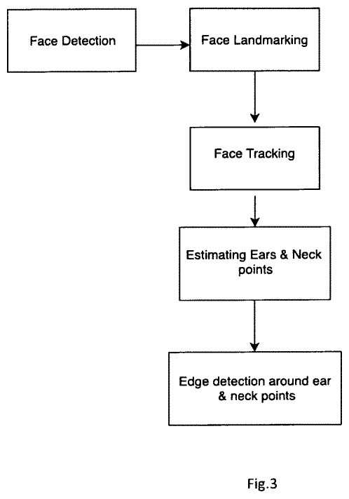

FIG. 3 shows steps in accordance with the present invention for detection of pre-designated parts of a user's body in the image of a human face. The present invention obviates the need of obtaining images with a visible ear lobe or neck, thereby greatly increasing the speed and efficiency with which the position of ear lobes or the neck can be determined.

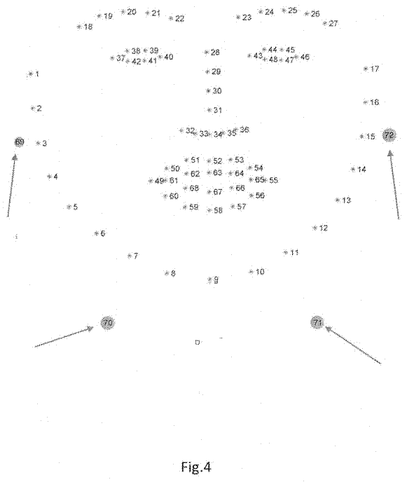

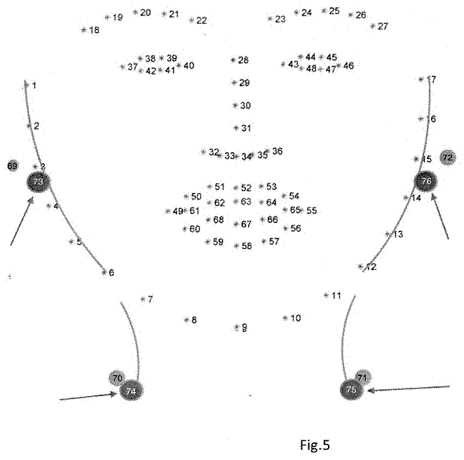

As shown in FIG. 4 further, the step for correction of rotation of the human face in an image about each of the axes involves determination of constant values which can be applied to the rotations along each of the axes. Thus after estimating Ear (69, 72) & Neck points (70, 71) are marked in FIG. 4, final edge detection and adjustment takes place. The inventive step of the present invention lies at processing as described in FIG. 3 and then achieving the end result as for detecting the position of an ear lobe and/or an ear helix and/or the neck in an image of a human face. FIG. 5 shows the edge detection further boosts the accuracy around the mathematically predicted ears (73, 76) & neck points (74, 75). In accordance with the present invention a radius of 0.05*faceHeight around the mathematically estimated points is used to find the exact edge of the neck/ear helix/ear lobe. The error in determination of the position of neck and ear lobes in accordance with the present invention is determined by comparing manually labelled center position of each neck and ear lobes with the position of ear lobe determined by adding the average offset distance to the reference face landmarking points. The value of constants across each of the axes is determined across a large number of images of human faces such that the error is minimized. The constants, once obtained, can then be applied to an image of a human face, even if the same is rotated along multiple axes so as to correct the rotation and determine the position of the ear lobe and edges of the neck on the human face.

The present invention uses this inventive process as an application to superimpose an image of an ornamental article in a moving image of a human face. It does so by cropping part of the input image that encompasses the face, determining reference face landmarking points falling on the jawline of the face and rotation of the face in the image, correcting the rotation of the face in the image, determining the vertical/height of the face, correcting the offset distance from reference face-landmarking points for the height of the face, and adding the offset distance to the reference face-landmarking points for determining the position of earlobes and neck edges on the image of the human face. The patented invention does not deduce the entire face shape. It only claims to find the coordinate of the jawline and the middle point between two eyebrows. By taking these points as reference, it develops a geometrical relationship to get the desired coordinates and also claims to accompany the system with an in-built manual error handling option.

While the preferred embodiments of the present invention have been described hereinabove, it should be understood that various changes, adaptations, and modifications may be made therein without departing from the spirit of the invention and the scope of the appended claims. It will be obvious to a person skilled in the art that the present invention may be embodied in other specific forms without departing from its spirit or essential characteristics. The described embodiments are to be considered in all respects only as illustrative and not restrictive.

1. Improved process for detection of position of body parts, such as an ear lobe, an ear helix and/or edges of the neck based on facial image comprises of;
an image capturing device, for capturing part of the facial image;
a display device for displaying or reproducing the facial image;
a processor unit for
determining and cropping part of the facial image along with reference face-landmarking points falling on the jawline of the face and rotation of the face image on x-axis, y-axis and/or z-axis; correcting the rotation of the face image;
determining the vertical size or height of the face image;
correcting the offset distance from reference face-landmarking points for the height of the face so determined;
adding the offset distance to reference face-landmarking points for determining the position of the pre-designated part of user's body on the image of the facial image; and
then achieving the end result as for detecting the position of an ear lobe and/or an ear helix and/or the neck in an image of a human face using edge detection.

2. The process as claimed in claim 1, wherein the step of correcting the rotation of the facial image includes correction along the x-axis, y-axis and/or z-axis, such that the rotation along each of the axes is 0 degrees.

3. The process as claimed in claim 1, wherein the step of determining the vertical size or height of the face is performed by determining the distance between face landmarking points falling on the uppermost layer of the points falling on the face 106 and face landmarking points falling on the lowermost layer of the points falling on the facial image.

4. The process claimed in claim 1, wherein the processor unit comprises one or more processors, which one or more processors include one or more or logic circuitries for processing instructions, general-purpose processors, special purpose processors, digital signal processors (DSP), microprocessors, micro-controllers, controller or the like.

5. The process claimed in claim 1, wherein the processor unit determines rotation of the facial image on x axis, y axis and/or z-axis.

6. The process claimed in claim 1, wherein the edge detection is used to adjust estimated ear and neck points by mathematically application of a radius of 0.05*face Height around the estimated points to accurately predict the ears and neck points of the facial image.

7. The process claimed in claim 1, wherein the process is used to superimpose an image of an ornamental article in a moving image of a human face

8. The process claimed in claim 1, wherein the process finds its application in the jewelry and fashion industry and can be used to superimpose an image related to fashion industry products onto a moving image of the human face.
